(19) United States
(12) Patent Application Publication
(10) Pub. No.: US 2019/0276290 A1
(43) Pub. Date: Sep. 12, 2019

(54) APPARATUS AND METHOD FOR TRANSPORTING AN OBJECT

(71) Applicants: CHRISTOPHER A. PARENT, SOUTH HADLEY, MA (US); MICHAEL L. ZANGA, ATHOL, MA (US); THOMAS G. FERGUSON, EAST LONGMEADOW, MA (US)

(72) Inventors: CHRISTOPHER A. PARENT, SOUTH HADLEY, MA (US); MICHAEL L. ZANGA, ATHOL, MA (US); THOMAS G. FERGUSON, EAST LONGMEADOW, MA (US)

(73) Assignee: C.A. PARENT DESIGN, LLC, HOLYOKE, MA (US)

(21) Appl. No.: 15/916,886

(22) Filed: Mar. 9, 2018

(51) Int. Cl. B66F 9/08; B62B 3/06; B62B 3/08

(52) U.S. Cl. CPC B66F 9/082; B62B 3/0606; B62B 2202/12; B62B 2202/10; B62B 3/08

(57) ABSTRACT

An apparatus for transporting an object is provided. The apparatus includes a mast and a carriage. The mast transitions between a first position defined by a first angle of incidence of the mast with a surface that supports the mast, and a second position defined by a second angle of incidence of the mast with the surface. The carriage traverses the mast and has one or more connectors that selectively secure the object to the carriage. The mast and the carriage are operative to transport the object along the surface when the mast is in the first position, and to facilitate engagement and disengagement of the one or more connectors with the object when the mast is in the second position.

### BACKGROUND

### Technical Field

Embodiments of the invention relate generally to the transportation of objects/cargo, and more specifically, to an apparatus for transporting an object.

### Discussion of Art

Many modern manufacturing facilities, e.g., warehouses and/or other types of industrial/commercial/research facilities, often have loading docks to facilitate the movement of goods/cargo from the facility to a wheeled trailer, also referred to herein simply as a “trailer”, or vice versa. Many loading docks are configured such that the walkway/bridge of the dock is nearly level with the floor of a trailer, e.g., the loading dock may have a recessed ramp which the wheeled trailer is backed down so that when the open end of the trailer is flush against the edge of the dock, the floor of the trailer is nearly level with the walkway of the dock. When the walkway/bridge of the dock is nearly level with the floor of a trailer, goods/cargo can be easily transferred from the facility to the wheeled trailer via a standard dolly, pallet jack, and/or forklift.

While such loading docks provide for an efficient means of transferring goods between a trailer and a facility, the recessed ramps of such docks often prove problematic for moving goods in and/or out of the encompassing facility in the absence of a trailer. In other words, it is usually very difficult to efficiently move goods/packages between the lower elevation pavement and the higher elevation of the bridge/walkway. While many traditional devices, such as forklifts, cranes, and lift platforms, are capable of moving good/packages between different elevations, the bodies of many such traditional devices, e.g., small cranes, often have one or more stabilizers, e.g., outriggers, that protrude from the front, i.e., the side of the main body configured to face the loading dock. Such forward facing stabilizers, however, often limit how close the main body of such traditional devices can be positioned with respect to the loading dock. Thus, many traditional devices require an operator to load/unload the cargo from/onto the bridge of a dock with the main body at a distance from the dock. Loading/unloading cargo from/onto a dock in such a manner, however, is often a slow, difficult, and/or dangerous process, as the operator of such a traditional device must take care to ensure that the center of gravity of the device, when loaded with cargo, does not shift to a point such that the device tips over.

What is needed, therefore, is an improved apparatus and method for transporting an object between two elevations, e.g., a loading dock/upper shelf and trailer/lower shelf.

### Brief Description

In an embodiment, an apparatus for transporting an object is provided. The apparatus includes a mast and a carriage. The mast transitions between a first position defined by a first angle of incidence of the mast with a surface that supports the mast, and a second position defined by a second angle of incidence of the mast with the surface. The carriage traverses the mast and has one or more connectors that selectively secure the object to the carriage. The mast and the carriage are operative to transport the object along the surface when the mast is in the first position, and to facilitate engagement and disengagement of the one or more connectors with the object when the mast is in the second position.

In another embodiment, a method for transporting an object is provided. The method includes transitioning a mast of an apparatus from a first position defined by a first angle of incidence of the mast with a surface that supports the mast, to a second position defined by a second angle of incidence of the mast with the surface. The method further includes engaging one or more connectors of a carriage, that traverses the mast, to the object; transitioning the mast from the second position to the first position and selectively securing the object to the carriage via the one or more connectors; and transporting the object along the surface via the mast and the carriage.

In yet another embodiment, an apparatus for transporting an object is provided. The apparatus includes a mast, a winch, and a carriage. The mast transitions between a first position defined by a first angle of incidence of the mast with a surface that supports the mast, and a second position defined by a second angle of incidence of the mast with the surface. The winch includes an elongated flexible member. The carriage is selectively connectable to the elongated member so as to traverse the mast via the winch, and has one or more connectors that selectively secure the object to the carriage. The mast and the carriage are operative to transport the object along the surface when the mast is in the first position, and to facilitate engagement and disengagement of the one or more connectors with the object when the mast is in the second position. The winch is operative to transport the object via the elongated member when the carriage is selectively disconnected from the elongated member and the mast is in the first position.

### DRAWINGS

The present invention will be better understood from reading the following description of non-limiting embodiments, with reference to the attached drawings, wherein below:

FIG. 1 is a diagram of an apparatus for transporting an object, in accordance with an embodiment of the present invention;

FIG. 2 is another diagram of the apparatus of FIG. 1, in accordance with an embodiment of the present invention;

FIG. 3 is a close-up view of a winch of the apparatus of FIG. 1, in accordance with an embodiment of the present invention;

FIG. 4 is a close-up view of a user control of the apparatus of FIG. 1, in accordance with an embodiment of the present invention;

FIGS. 5A-5H depict an action sequence of a method of transporting an object utilizing the apparatus of FIG. 1, in accordance with an embodiment of the present invention; and

FIG. 6 is diagram of another embodiment of the apparatus of FIG. 1 wherein the apparatus includes a platform, in accordance with an embodiment of the present invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

As used herein, the terms “substantially,” “generally,” and “about” indicate conditions within reasonably achievable manufacturing and assembly tolerances, relative to ideal desired conditions suitable for achieving the functional purpose of a component or assembly. As used herein, “electrically coupled,” “electrically connected,” and “electrical communication” mean that the referenced elements are directly or indirectly connected such that an electrical current may flow from one to the other. The connection may include a direct conductive connection, i.e., without an intervening capacitive, inductive or active element, an inductive connection, a capacitive connection, and/or any other suitable electrical connection. Intervening components may be present. The term “real-time,” as used herein, means a level of processing responsiveness that a user senses as sufficiently immediate or that enables the processor to keep up with an external process.

Further, while the embodiments disclosed herein are described with respect to an apparatus for moving cargo on and off a loading dock, it is to be understood that embodiments of the present invention may be applicable to other scenarios in which an object must be moved from a first location having a first elevation to a second location having a second elevation different from the first.

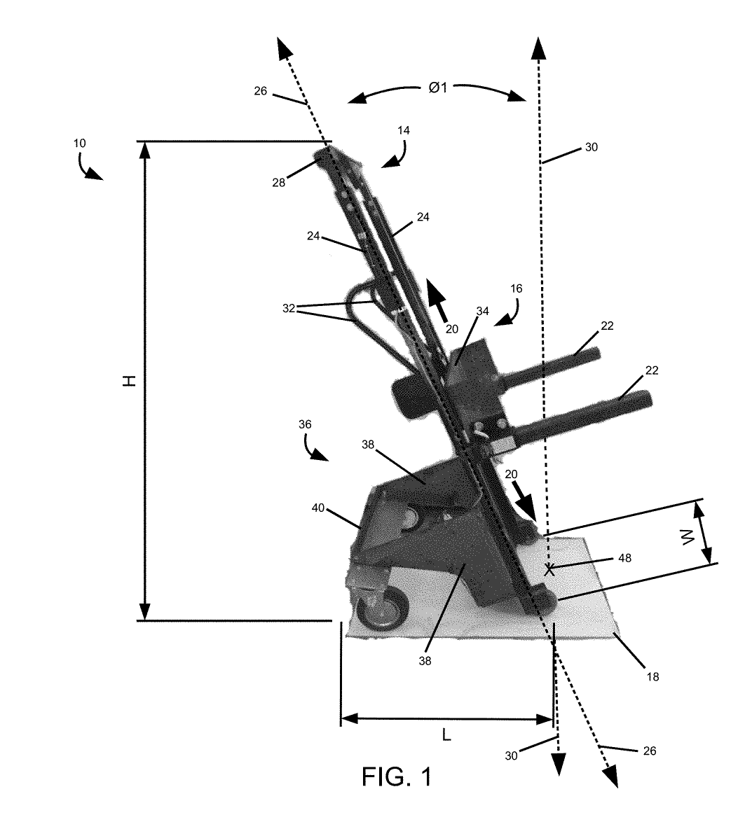

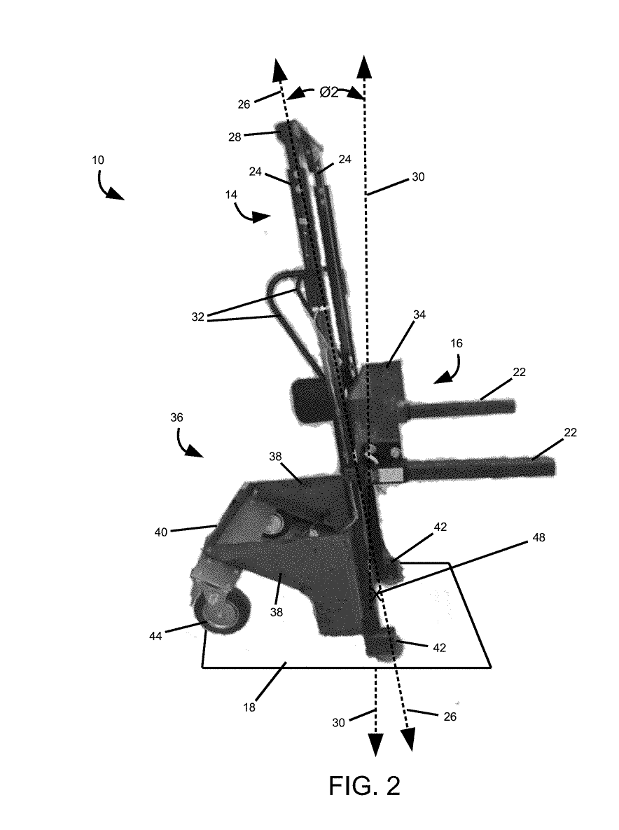

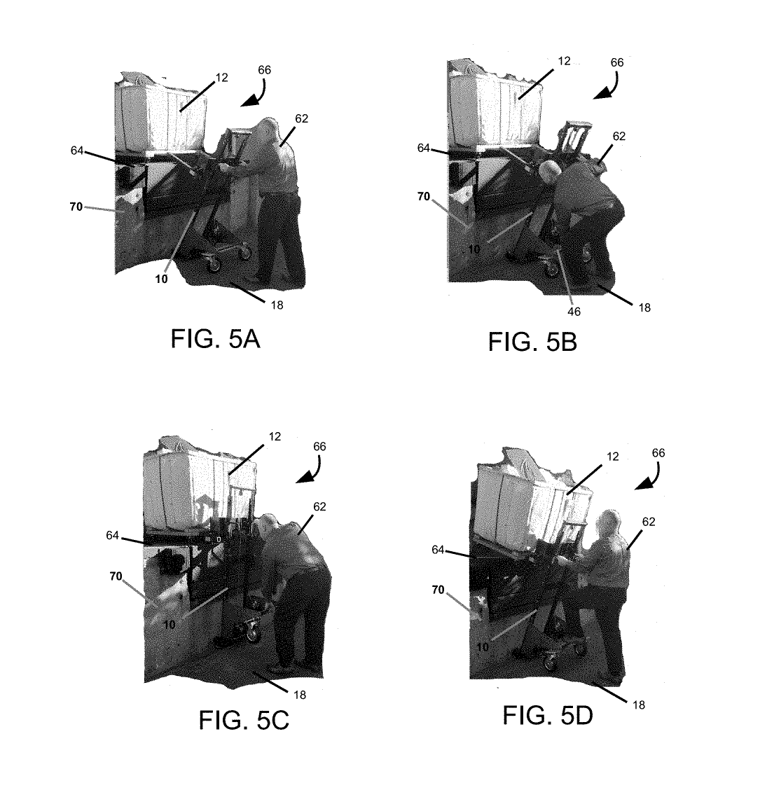

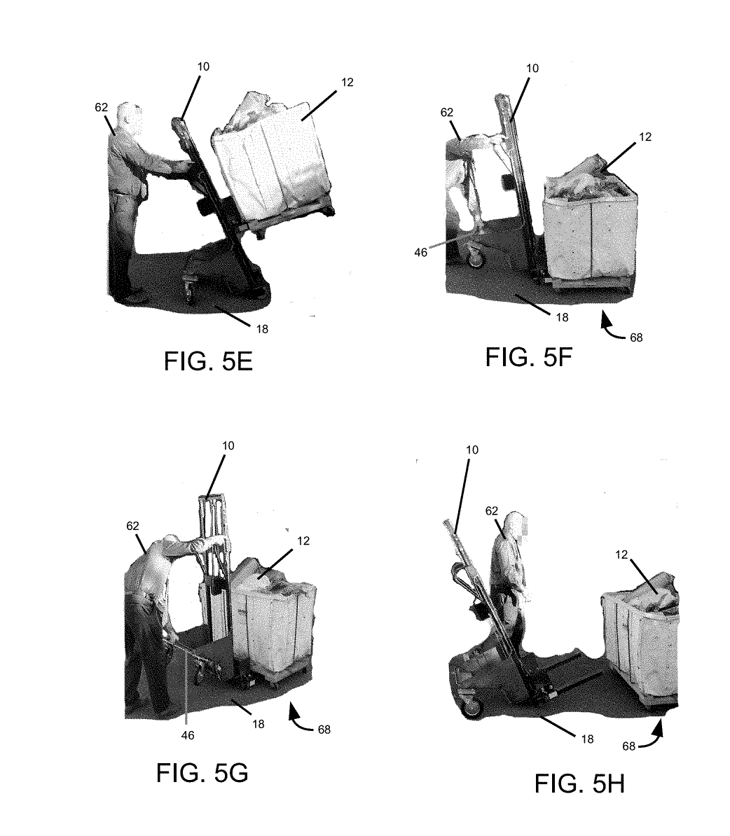

Accordingly, referring now to FIGS. 1 and 2, an apparatus 10 for transporting an object/cargo 12 (FIGS. 5A-5H) is shown. The apparatus 10 includes a mast 14 and a carriage 16. The mast 14 transitions between a first/resting position defined by a first angle of incidence Ø₁ of the mast 14 with a surface 18, e.g., the ground, a floor, a platform, etc., that supports the mast 14, as best seen in FIG. 1, and a second/engagement position defined by a second angle of incindence Ø₂ of the mast 14 with the surface 18 as best seen in FIG. 2. The carriage 16 traverses the mast 14, i.e., moves along the longitudinal axis of the mast 14 as indicated by arrows 20 (FIG. 1), and has one or more connectors 22, e.g., forks, that selectively secure the cargo 12 to the carriage 16. As will be explained in greater detail below, the mast 14 and the carriage 16 are operative to transport the cargo 12 along the surface 18 when the mast 14 is in the first/resting position, as best seen in FIG. 5E, and to facilitate engagement and disengagement of the one or more connectors 22 with the cargo 12 when the mast 14 is in the second/engagement position, as best seen in FIGS. 5C and 5G.

As illustrated in FIGS. 1 and 2, the mast 14 may include one or more longitudinal beams 24 that define a longitudinal axis 26 and may be connected to each other by one or more cross beams 28. As used herein, the term “angle of incidence” refers to the angle Ø at which the longitudinal axis 26 intercepts a normal line/axis 30 of the surface 18. In certain aspects, Ø₁ may be between about 10° to about 45°, e.g., 30°, and Ø₂ may be between about −10° to about 10°, e.g., 0°. The longitudinal beams 24 may be sized such that the apparatus 10, when in the first/resting position, has a height H (FIG. 1) of between about sixty inches (60″) to about eighty inches (80″), a length L (FIG. 1) of between about thirty inches (30″) to about forty inches (40″), and a width W (FIG. 1) of between about twenty inches (′20″) to about thirty inches (30″). The longitudinal beams 24 may each have a track/groove which secures the carriage 16 to the mast 14 as the carriage 16 traverses the mast 14, i.e., moves along the longitudinal axis 26. In certain aspects, the mast 14 may also include one or more handles 32, which, in embodiments, may be disposed on the longitudinal beams 24.

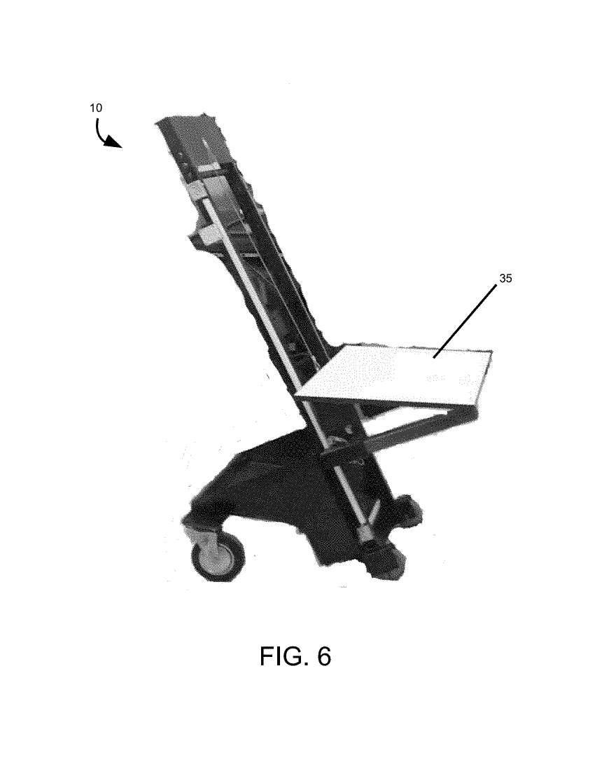

The carriage 16 may include a substrate/plate 34 to which the connectors 22 may be secured, mounted, and/or otherwise attached to. In embodiments where the longitudinal beams 24 include grooves and/or tracks for securing the carriage 16 to the mast 14, the substrate 34 may include one or more portions that fit/mate to the grooves/tracks of the mast 14. As stated above, the carriage 16 traverses the mast 14, i.e., moves along the longitudinal axis 26, which, as will be appreciated, selectively adjusts the elevation of the connectors 22 with respect to the surface 18. While the accompanying figures depict the connectors 22 as pallet forks, it will be understood that, in other embodiments, the connectors 22 may be at least one of a hitch ball, hook, clamp, magnet, and/or any other type of device capable of securing an object/cargo to the mast 14. In embodiments, the connectors 22 may be substituted and/or supplemented with/by a table 35 (FIG. 6) and/or other platform. In such embodiments, the apparatus 10 may transport an object on the table 35 without need of rocking/tilting the apparatus 10. For example, the table 35 may move along the mast 14 such that the object can be moved from a lower shelf/platform to a higher self/platform. As will be understood, however, embodiments of the apparatus 10 including a table 35 may still be rocked/tiled as described herein. In other embodiments, the connectors 22 may be substituted with a chain hoist.

In embodiments, the apparatus 10 may further include a tilting base 36 disposed on the mast 14 and operative to facilitate transition of the mast 14 between the first position (FIG. 1) and the second positions (FIG. 2). As shown in FIG. 1, the tilting base 36 may be disposed such that it stabilizes/supports the mast 14 and carriage 16 when the apparatus 10 is in the first position. In other words, in embodiments, the tilting base 36 may prevent the mast 14 and carriage 16 from falling over/down with respect to the surface 18. As such, the tilting base 36 may include one or more side portions 38 connected together via one or more cross bars 40. While the accompanying figures depict the side portions 38 as having an angled shape, it is to be understood that the side portions 38 may have any shape, e.g., curved, that is operative to support the mast 14 and carriage 16 in the first position. The tilting base 36 may also include one or more wheels 42, 44 (FIG. 2) to facilitate movement of the apparatus 10 across the surface 18. As will be appreciated, in embodiments, the wheels may be split in to a first pair 42 that are casterless and a second pair 44 that include casters such that the apparatus 10 has rear-steering. In embodiments, the tilting base 36 may further include one or more handles 46 (best seen in FIGS. 5B, 5F, and 5G) which may be disposed on one of the cross bars 40.

Accordingly, transition of the mast 14 from the first position (FIG. 1) to the second position (FIG. 2), or vice versa, may be facilitated by pivoting the mast 14 about a point 48 on the surface 18 until the longitudinal axis 26 of the mast 14 reaches Ø₂ or Ø₁. In embodiments, transition of the mast 14 between the first and second positions may be facilitated/assisted via handles 32 and/or 46 (FIGS. 5B, 5F, and 5G).

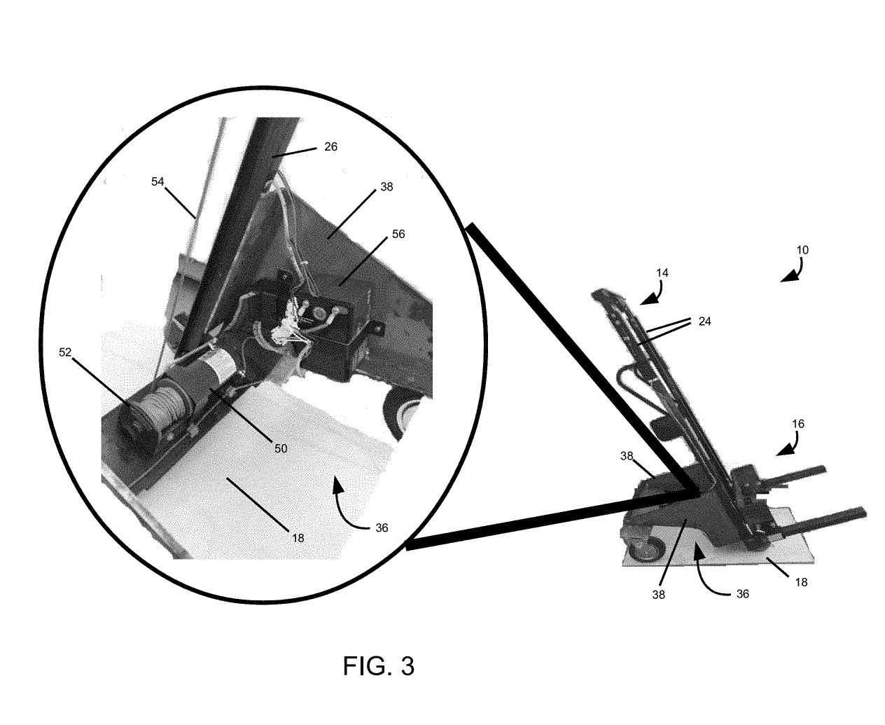

Turning now to FIG. 3, in embodiments, the apparatus 10 may further include one or more motors 50 and/or winches 52 that facilitate traversal of the carriage 16 along the mast 14. For example, in embodiments having a winch 52 powered via a motor 50, and/or via manual power, e.g., a hand crank, the winch 52 may be mechanically connected to the carriage 16 via an elongated flexible member 54, e.g., a cable, chain, rope, belt, etc., that pulls the carriage 16 up the mast 14, i.e., the direction along the mast 14 generally opposing the force of gravity, while allowing the carriage 16 to sink back down the mast 14, i.e., in the direction along the mast 14 generally aligned with the force of gravity. In such embodiments, the apparatus 10 may further include one or more safety switches that prevent the flexible member 54 from overrunning the length of travel of the mast 14. Additionally, the side portions 38 and cross bars 40 may be removeably attached to the mast 14 in order to ease transportation and/or storage of the apparatus 10 via a vehicle, e.g., a truck, van, etc. In other words, in embodiments, the tilting base 36 may be removable from the mast 14 in order to facilitate/ease transportation and/or storage of the apparatus 10, e.g., storing the apparatus 10 in the trunk of a car.

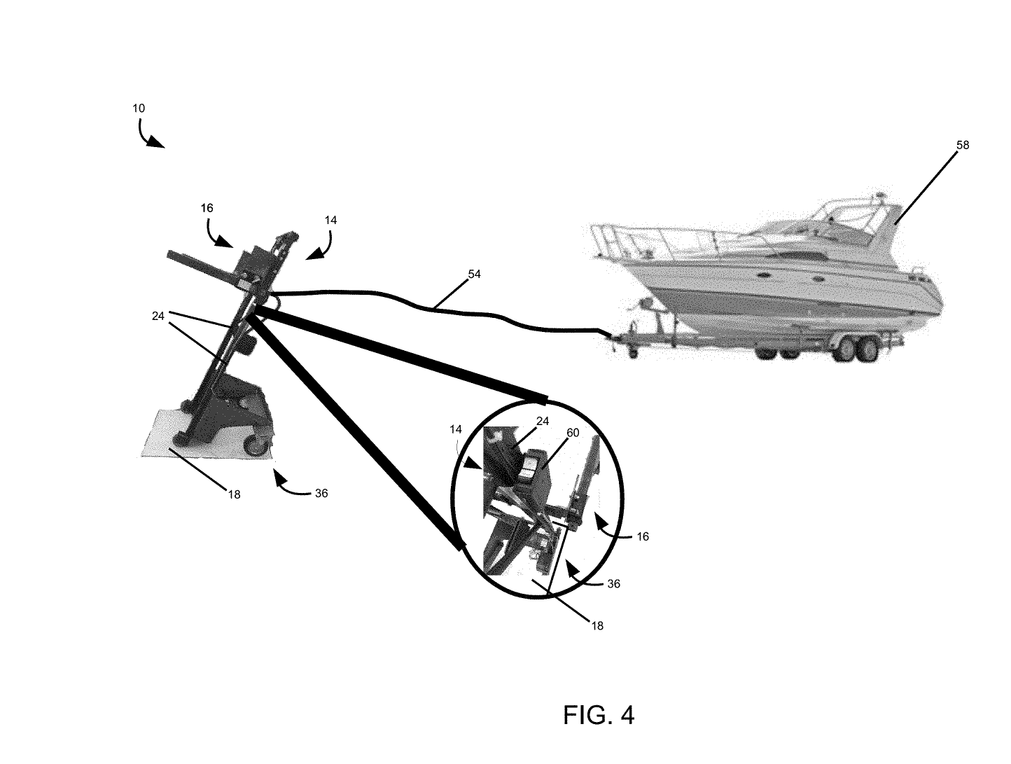

As further shown in FIG. 3, the motor 50 and/or winch 52 may be disposed between the side portions 38 of the tilting base 36. It will be understood, however, that the motor 50 and/or winch 52 may be disposed in other locations on the apparatus 10. Further, while the accompanying figures depict the motor 50 as powering a winch 52 that pulls the carriage 16 along the mast 14 via a cable 54, it is to be understood the motor 50 of other embodiments may facilitate movement of the carriage 16 in other ways. For example, in embodiments, the longitudinal beams 24 of the mast 14 may have a toothed track with the motor 50 disposed on the carriage 16 so as to power one or more gears, also disposed on the carriage 16, that traverse the toothed track. The motor 50 may be electric, gas, hydraulic, and/or pneumatic. In embodiments where the motor 50 is electric, the apparatus 10 may further include a battery 56, e.g., a 12VDC, that supplies an electric current to the motor 50 and may also be disposed between the side portions 38. As illustrated in FIG. 4, in embodiments, the flexible member 54 may be selectively connectable to the carriage 16. In such embodiments, the winch 52 may be operative to transport an object 58, e.g., a car, boat, etc., across a surface which may and/or may not be at the same elevation as the surface 18 which supports the apparatus 10. In embodiments, the apparatus 10 may include a load meter that provides an indication of a load on the winch 52 and/or apparatus 10, which, as will be appreciated, may assist an operator of the apparatus 10 from overloading/overstressing the winch 52 and/or apparatus 10.

As further illustrated in FIG. 4, in embodiments, one or more user controls 60, e.g., switches, buttons, etc., in electrical communication with the motor 50, may be disposed on the mast 14, e.g., one on each longitudinal beam 24, that provide for a user/operator of the apparatus 10 to selectively adjust the position of the carriage 16 along the mast 14. As will be appreciated, embodiments may have two or more controls 60, with each control 60 being redundant with respect to the others. While the accompanying figures depict the controls 60 as being directly mounted to the apparatus 10, it will be understood that, in other embodiments, the controls 60 may be remote, e.g., a smart phone interface that electronically communicates with a wireless controller disposed on the apparatus 10 that controls the direction of the motor 50. In other embodiments, the controls 60 may be disposed on a console disposed away from but hard wired to the apparatus 10, e.g., a handheld console connected to the motor 50 via an electrical wire.

Moving now to FIGS. 5A-5H, an action sequence depicting a method for transporting an object/cargo 12 utilizing the apparatus 10 is shown. Specifically, FIGS. 5A-5H depict an operator 62 using the apparatus 10 to transport a pallet of cargo 12 from the elevated bridge/walkaway 64 of a loading dock 66 (FIGS. 5A-5D) to a location 68 (FIGS. 5F-5H) on a surface 18 having a lower elevation than the bridge/walkway 64. Accordingly, as shown in FIG. 5A, the operator 62, with the apparatus 10 in the first position, may move/slide the apparatus 10 via the handles 32 such that the bottom of the mast 14 abuts the wall 70 of the dock 66. The operator 62, using handles 32 and/or 46 may then transition the mast 14 to the second position, adjust the height of the forks 22 via the controls 60 such that the forks 22 align with the pallet 12, and engage the forks 22 with the pallet 12 as seen in FIGS. 5B-5C. With the forks 22 engaged with the pallet 12, the operator 62 may then slightly raise the forks 22 via the controls 60 such that the pallet 12 becomes supported by the forks 22, and then transition the mast 14 back to the first position via the handles 32 and/or 46 such that the pallet 12 becomes secured to the mast 14 via the forks 22 as shown in FIG. 5D.

As illustrated in FIG. 5E, with the pallet 12 secured to the mast 14, the operator 62 may then lower the forks 22 via the controls 60 so as to lower the center of gravity of the pallet 12, which in turn, may improve stability of the pallet 12 during transport across the surface 18 via the apparatus 10. As will be appreciated, the location of the controls 60 on the longitudinal beams 24, in combination with pivoting the mast 14 via the handles 32 and/or 46, may provide for the operator 62 to simultaneously pivot and lower the center of gravity of the pallet towards the operator 62 so that the center of gravity stabilizes between the pairs of wheels 42 and 44. The operator 62 may then push/pull the apparatus 10 with the mast 14 in the first position via handles 32 to the location 68.

Upon arriving at the location 68, the operator 62 may: transition the mast 14 to the second position via handles 32 and/or 46 so that the pallet 12 becomes unsecured from the mast 14, as shown in FIG. 5F; adjust/lower the forks 22 via the controls 60 so that the surface 18 supports the pallet 12, as shown in FIG. 5G; and then disengage the forks 22 from the pallet 12 and transition the mast 14 back to the first position, as shown in FIG. 5H.

As will be understood, the pallet 12 may be transferred from the location 68 back up onto the bridge/walkway 64 of the dock 66 by executing the above steps in reverse. In embodiments, the mast 14, carriage 16, tilting base 36, and/or motor 50 may be operative to transport an object weighing up to five hundred pounds (500 lbs). As will be appreciated, however, other embodiments of the apparatus 10 may be configured to transport objects weighing more than five hundred pounds (500 lbs). Accordingly, the mast 14, carriage 16, and/or tilting base 36 may be made of plastics, metals, e.g., steel, copper, aluminum, titanium, wood, and/or other materials suitable for supporting over five hundred pounds (500 lbs) of weight.

Finally, it is also to be understood that the apparatus 10 may include the necessary electronics, software, memory, storage, databases, firmware, logic/state machines, microprocessors, communication links, displays or other visual or audio user interfaces, printing devices, and any other input/output interfaces to perform the functions described herein and/or to achieve the results described herein. For example, as previously mentioned, the system may include at least one processor, e.g., an onboard wireless controller, and system memory/data storage structures, which may include random access memory (RAM) and read-only memory (ROM). The at least one processor of the system 10 may include one or more conventional microprocessors and one or more supplementary co-processors such as math co-processors or the like. The data storage structures discussed herein may include an appropriate combination of magnetic, optical and/or semiconductor memory, and may include, for example, RAM, ROM, flash drive, an optical disc such as a compact disc and/or a hard disk or drive.

Additionally, a software application that adapts the controller to perform the methods disclosed herein may be read into a main memory of the at least one processor from a computer-readable medium. The term “computer-readable medium”, as used herein, refers to any medium that provides or participates in providing instructions to the at least one processor of the system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, a RAM, a PROM, an EPROM or EEPROM (electronically erasable programmable read-only memory), a FLASH-EEPROM, any other memory chip or cartridge, or any other medium from which a computer can read.

While in embodiments, the execution of sequences of instructions in the software application causes at least one processor to perform the methods/processes described herein, hard-wired circuitry may be used in place of, or in combination with, software instructions for implementation of the methods/processes of the present invention. Therefore, embodiments of the present invention are not limited to any specific combination of hardware and/or software.

It is further to be understood that the above description is intended to be illustrative, and not restrictive. For example, the above-described embodiments (and/or aspects thereof) may be used in combination with each other. Additionally, many modifications may be made to adapt a particular situation or material to the teachings of the invention without departing from its scope.

For example, in an embodiment, an apparatus for transporting an object is provided. The apparatus includes a mast and a carriage. The mast transitions between a first position defined by a first angle of incidence of the mast with a surface that supports the mast, and a second position defined by a second angle of incidence of the mast with the surface. The carriage traverses the mast and has one or more connectors that selectively secure the object to the carriage. The mast and the carriage are operative to transport the object along the surface when the mast is in the first position, and to facilitate engagement and disengagement of the one or more connectors with the object when the mast is in the second position. In certain embodiments, the first angle of incidence is between about 10° to about 45°, and the second angle of incidence is between about −10° to about 10°. In certain embodiments, the mast transitions between the first position and the second position by pivoting about a point disposed on the surface. In certain embodiments, the apparatus further includes a tilting base disposed on the mast and operative to facilitate transition of the mast between the first position and the second position. In certain embodiments, the tilting base facilitate transition of the mast between the first position and the second position via pivoting about a point disposed on the surface. In certain embodiments, the tilting base is disposed on the mast so as to stabilize the mast and the carriage when the mast is in the first position. In certain embodiments, the tilting base includes a first handle and the mast includes a second handle, and the tilting base facilitates transition of the mast between the first position and the second position via at least one of the first and the second handles. In certain embodiments, the apparatus further includes a motor that facilitates traversal of the mast by the carriage. In certain embodiments, at least one of the one or more connectors is at least one of a fork, a hitch ball, a hook, a clamp, a platform, a platform, and a magnet. In certain embodiments, the apparatus further includes one or more caster wheels operative to facilitate transportation of the object via the mast and the carriage along the surface.

Yet other embodiments provide a method for transporting an object. The method includes transitioning a mast of an apparatus from a first position defined by a first angle of incidence of the mast with a surface that supports the mast, to a second position defined by a second angle of incidence of the mast with the surface. The method further includes engaging one or more connectors of a carriage, that traverses the mast, to the object; transitioning the mast from the second position to the first position and selectively securing the object to the carriage via the one or more connectors; and transporting the object along the surface via the mast and the carriage. In certain embodiments, the method further includes transitioning the mast from the first position to the second position and selectively unsecuring the object from the carriage via the one or more connectors. In certain embodiments, the method further includes selectively traversing the carriage along the mast while the object is secured to the carriage via the one or more connectors and while the mast is in the first position. In certain embodiments, the first angle of incidence is between about 10° to about 45°, and the second angle of incidence is between about −10° to about 10°. In certain embodiments, transitioning the mast from the first position to the second position, and transitioning the mast from the second position to the first position each include pivoting the mast about a point disposed on the surface. In certain embodiments, the apparatus further includes a tilting base disposed on the mast. In such embodiments, transitioning the mast from the first position to the second position, and transitioning the mast from the second position to the first position each include pivoting the tilting base about a point disposed on the surface. In certain embodiments, pivoting the tilting base about a point disposed on the surface is facilitated via a first handle disposed on the tilting base and a second handle disposed on the mast. In certain embodiments, the method further includes stabilizing the mast and the carriage via a tilting base when the mast is in the first position. In such embodiments, the tilting base is disposed on the mast. In certain embodiments, at least one of the one or more connectors is at least one of a fork, a hitch ball, a hook, a clamp, and a magnet.

Yet still other embodiments provide for an apparatus for transporting an object. The apparatus includes a mast, a winch, and a carriage. The mast transitions between a first position defined by a first angle of incidence of the mast with a surface that supports the mast, and a second position defined by a second angle of incidence of the mast with the surface. The winch includes an elongated flexible member. The carriage is selectively connectable to the elongated member so as to traverse the mast via the winch, and has one or more connectors that selectively secure the object to the carriage. The mast and the carriage are operative to transport the object along the surface when the mast is in the first position, and to facilitate engagement and disengagement of the one or more connectors with the object when the mast is in the second position. The winch is operative to transport the object via the elongated member when the carriage is selectively disconnected from the elongated member and the mast is in the first position.

Accordingly, by providing for a mast that transitions between two positions, as described above, wherein the mast engages a pallet in a rocked forward position while transporting the pallet in a tilted resting position, some embodiments of the present invention may provide for an apparatus for transporting pallets that, unlike traditional devices of moving pallets, does not require the use of forward facing outriggers for stability. Accordingly, some embodiments of the present invention may provide for an apparatus for transporting pallets that has a smaller form factor than traditional forklifts, which in turn, may makes such embodiments of the present invention lighter and/or easier to maneuver than traditional object moving devices. In particular, by not utilizing forward facing outriggers/supports, some embodiments of the present invention are able to be positioned closer to the wall of a loading dock than traditional object moving devices, which in turn, reduces the distance that the connectors, e.g., forks, have to be extended in order to engage and disengage a pallet. Thus, some embodiments of the present invention are safer to operate than traditional forklifts.

Further, by incorporating an electric motor, some embodiments of the present invention have a lower emissions rate than many traditional forklifts.

Additionally, while the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

What is claimed is:

1. An apparatus for transporting an object comprising:
a mast that transitions between a first position defined by a first angle of incidence of the mast with a surface that supports the mast, and a second position defined by a second angle of incidence of the mast with the surface;
a carriage that traverses the mast and has one or more connectors that selectively secure the object to the carriage; and
wherein the mast and the carriage are operative to transport the object along the surface when the mast is in the first position, and to facilitate engagement and disengagement of the one or more connectors with the object when the mast is in the second position.

2. The apparatus of claim 1, wherein
the first angle of incidence is between about 10° to about 45°, and
the second angle of incidence is between about −10° to about 10°.

3. The apparatus of claim 1, wherein the mast transitions between the first position and the second position by pivoting about a point disposed on the surface.

4. The apparatus of claim 1 further comprising:
a tilting base disposed on the mast and operative to facilitate transition of the mast between the first position and the second position.

5. The apparatus of claim 4, wherein the tilting base facilitate transition of the mast between the first position and the second position via pivoting about a point disposed on the surface.

6. The apparatus of claim 4, wherein the tilting base is disposed on the mast so as to stabilize the mast and the carriage when the mast is in the first position.

7. The apparatus of claim 4, wherein
the tilting base includes a first handle and the mast includes a second handle, and
the tilting base facilitates transition of the mast between the first position and the second position via at least one of the first and the second handles.

8. The apparatus of claim 1 further comprising:
a motor that facilitates traversal of the mast by the carriage.

9. The apparatus of claim 1, wherein at least one of the one or more connectors is at least one of a fork, a hitch ball, a hook, a clamp, a platform, and a magnet.

10. The apparatus of claim 1 further comprising:
one or more caster wheels operative to facilitate transportation of the object via the mast and the carriage along the surface.

11. A method for transporting an object comprising:
transitioning a mast of an apparatus from a first position defined by a first angle of incidence of the mast with a surface that supports the mast, to a second position defined by a second angle of incidence of the mast with the surface;
engaging one or more connectors of a carriage, that traverses the mast, to the object;
transitioning the mast from the second position to the first position and selectively securing the object to the carriage via the one or more connectors; and
transporting the object along the surface via the mast and the carriage.

12. The method of claim 11 further comprising:
transitioning the mast from the first position to the second position and selectively unsecuring the object from the carriage via the one or more connectors.

13. The method of claim 11 further comprising:
selectively traversing the carriage along the mast while the object is secured to the carriage via the one or more connectors and while the mast is in the first position.

14. The method of claim 11, wherein
the first angle of incidence is between about 10° to about 45°, and
the second angle of incidence is between about −10° to about 10°.

15. The method of claim 11, wherein transitioning the mast from the first position to the second position, and transitioning the mast from the second position to the first position each comprise:
pivoting the mast about a point disposed on the surface.

16. The method of claim 11, wherein
the apparatus further includes a tilting base disposed on the mast, and
transitioning the mast from the first position to the second position, and transitioning the mast from the second position to the first position each comprise:
pivoting the tilting base about a point disposed on the surface.

17. The method of claim 16, wherein pivoting the tilting base about a point disposed on the surface is facilitated via a first handle disposed on the tilting base and a second handle disposed on the mast.

18. The method of claim 11 further comprising:
stabilizing the mast and the carriage via a tilting base when the mast is in the first position, wherein the tilting base is disposed on the mast.

19. The method of claim 11, wherein at least one of the one or more connectors is at least one of a fork, a hitch ball, a hook, a clamp, a platform, and a magnet.

20. An apparatus for transporting an object comprising:
a mast that transitions between a first position defined by a first angle of incidence of the mast with a surface that supports the mast, and a second position defined by a second angle of incidence of the mast with the surface;
a winch that includes an elongated flexible member;
a carriage selectively connectable to the elongated member so as to traverse the mast via the winch, the carriage having one or more connectors that selectively secure the object to the carriage; and
wherein the mast and the carriage are operative to transport the object along the surface when the mast is in the first position, and to facilitate engagement and disengagement of the one or more connectors with the object when the mast is in the second position; and
wherein the winch is operative to transport the object via the elongated member when the carriage is selectively disconnected from the elongated member and the mast is in the first position.
